(19) United States
(12) Patent Application Publication
(10) Pub. No.: US 2003/0149577 A1
(43) Pub. Date: Aug. 7, 2003

(54) Online client procurement system for attorneys

(76) Inventors: Thomas Lowe Young, Tampa, FL (US); Nicholas J. Carroll, Tampa, FL (US)

Correspondence Address: FOWLER WHITE BOGGS BANKER, P.A., 501 E. KENNEDY BOULEVARD, SUITE 1700, TAMPA, FL, 33602, US

(21) Appl. No.: 10/152,093

(22) Filed: May 21, 2002

Related U.S. Application Data
(60) Provisional application No. 60/292,859, filed on May 22, 2001.

(51) Int. Cl. G06F 17/60

(52) U.S. Cl. 705/1

(57) ABSTRACT

An online client procurement system and a method for personal injury attorneys used for facilitating the formation of attorney/client relationships. The invention includes a business method for procuring clients for attorneys which utilizes an Internet website which queries a relational database that associates information relating to various medical conditions, diseases and injuries with the acts, omissions, products and services that commonly cause such medical conditions, diseases and injuries; a detailed intake form customized to reflect the user's medical condition, disease, injury, act, omission, product or service of interest; a feature that routes such intake forms to the attorney who has purchased the rights to the geographical area represented by the user's zip code, or state boundary; a product recall profiler that allows users to be notified when products or services that the user has indicated interest in are recalled or their safety otherwise called into question; a system for tracking, monitoring, analyzing and reporting medical conditions, diseases and injuries that are caused by acts, omissions, products or services. Intake forms are highly specialized based on the location of the user within the database and the forms are used by subscribing attorneys to evaluate the merits of the user's/potential client's case. The intake form is routed to an attorney who has purchased the rights to the geographical area represented by the user's zip code, or state boundary. The user may complete a detailed profile form describing products or services of interest to the user. The monitoring and tracking system evaluates developing trends with regard to acts, omissions, products or services that cause medical conditions, diseases and injuries in order to report such trends to the proper government agencies and to attorneys who subscribe to the service.

### CROSS REFERENCES TO RELATED APPLICATION

This application is entitled to the benefit of Provisional Patent Application, Serial No. 60/292,859 filed May 22, 2001, in the United States Patent and Trademark Office.

### ABSTRACT OF THE DISCLOSURE

An online client procurement system and a method for personal injury attorneys used for facilitating the formation of attorney/client relationships. The invention includes a business method for procuring clients for attorneys which utilizes an Internet website which queries a relational database that associates information relating to various medical conditions, diseases and injuries with the acts, omissions, products and services that commonly cause such medical conditions, diseases and injuries; a detailed intake form customized to reflect the user's medical condition, disease, injury, act, omission, product or service of interest; a feature that routes such intake forms to the attorney who has purchased the rights to the geographical area represented by the user's zip code, or state boundary; a product recall profiler that allows users to be notified when products or services that the user has indicated interest in are recalled or their safety otherwise called into question; a system for tracking, monitoring, analyzing and reporting medical conditions, diseases and injuries that are caused by acts, omissions, products or services. Intake forms are highly specialized based on the location of the user within the database and the forms are used by subscribing attorneys to evaluate the merits of the user's/potential client's case. The intake form is routed to an attorney who has purchased the rights to the geographical area represented by the user's zip code, or state boundary. The user may complete a detailed profile form describing products or services of interest to the user. The monitoring and tracking system evaluates developing trends with regard to acts, omissions, products or services that cause medical conditions, diseases and injuries in order to report such trends to the proper government agencies and to attorneys who subscribe to the service.

### BACKGROUND OF THE INVENTION

1. Field of the Invention

The present invention relates to legal marketing and more specifically it relates to an online client procurement system for attorneys that facilitates the formation of attorney-client relationships, including an online procurement system and a method for establishing the relationship, specifically for personal injury attorney and clients.

2. Description of the Prior Art

It is known that legal marketing techniques have been in use. Legal marketing involves the use of conventional media including, but not limited to, television, print, radio and outdoor advertising, as well as online Internet websites. Today there are many Internet websites that are comprised of either medical or legal information.

The main problem with existing World Wide Web based client procurement systems is that they do not relate and associate various medical conditions, diseases and injuries with the factors that commonly cause or contribute to such medical conditions, diseases and injuries. The association of certain acts, omissions, services and products with the medical conditions, diseases and injuries that such acts, omissions, services and products may cause is necessary to demonstrate the legal liability of the person or entity responsible for such service or product. As such, a vast latent market for plaintiff personal injury legal representation continues untapped as potential clients remain ignorant of the cause(s) of their medical conditions, diseases or injuries. Another problem with conventional World Wide Web based client procurement systems is that they do not utilize an online mechanism to match potential clients with personal injury attorneys located in the client's immediate geographical area. Yet another problem with conventional World Wide Web based client procurement systems is that they do not take advantage of the Internet's ability to customize the client intake and case evaluation process. Existing services typically utilize generalized intake forms on their Internet websites rather than customized intake forms designed to efficiently process a potential client's legal claim.

While these currently existing World Wide Web based client procurement systems may be suitable for the particular purpose to which they address, they are not as suitable for facilitating the formation of attorney/client relationships in the context of personal injury legal practice.

### SUMMARY OF THE INVENTION

The present invention provides a new online client procurement system for attorneys wherein the same can be utilized for facilitating the formation of attorney-client relationships.

The present invention includes a system to provide a novel online client procurement system for personal injury attorneys, so as to establish a direct Attorney/Client relationship in a specific geographical location, such as a state boundary.

The advantage of the present invention comprises a business method for procuring clients for attorneys which utilizes a relational database that associates information relating to various medical conditions, diseases and injuries with the acts, omissions, products and services that commonly cause such medical conditions, diseases and injuries; a detailed intake medical and legal form customized to reflect the user's medical condition, disease, injury, product or service; a feature that routes such intake forms to the attorney who has purchased the rights to the geographical area represented preferably by the user's zip code, state boundary, or telephone area code; a product recall profiler that allows users to be notified when products the user has indicated interest in are recalled. A system for tracking, monitoring, analyzing and reporting medical conditions, diseases and injuries that are caused by acts, omissions, products or services. The database associates information relating to various medical conditions, diseases and injuries with the acts, omissions, products and services that commonly cause such medical conditions, diseases and injuries. Intake medical and legal forms are highly specialized based on the location of the user within the database and the forms are used by subscribing attorneys to evaluate the merits of the user's/potential client's case. The intake form is routed to an attorney who has purchased the rights to the geographical area represented by the user's zip code or state boundary. The user will complete a detailed profile form describing products or services of interest to the user. At such time that the products or services of interest become the subject of a recall, the user shall be so notified via electronic mail. The monitoring and tracking system evaluates developing trends with regard to acts, omissions, products or services that cause medical conditions, diseases and injuries in order to report such trends to the proper government agencies and to attorneys who subscribe to the service.

The present invention also includes a method of online client procurement through the use of the Internet and to establish this procurement by the following steps:

a) Establishing entry to a relational database on the Internet, established by an Attorney; and

b) Reviewing the database and coordinating with the Attorney, specifically located in a geographical location with respect to a potential Client, such as a state boundary.

An object of the present invention is to provide an online client procurement system for personal injury attorneys that will overcome the shortcomings of the prior art business methods and to provide an online client procurement system for personal injury attorneys for facilitating the formation of attorney/client relationships.

Another object is to provide an online client procurement system for personal injury attorneys that facilitates the process of securing legal representation for personal injury victims and their families so as to create a valuable service to injury victims and their families and to personal injury attorneys.

Another object is to provide an online client procurement system for personal injury attorneys that associates medical conditions, diseases and injuries with the common causes of such medical conditions, diseases and injuries, and that also educates consumers of acts, omissions, products or services as to the medical conditions, diseases and injuries that such acts, omissions, products or services may cause.

Another object is to provide an online client procurement system for personal injury attorneys that educates victims of medical conditions, diseases and injuries as to the acts, omissions, products or services that cause such medical conditions, diseases and injuries.

Another object is to provide an online client procurement system for personal injury attorneys that utilizes the relationships between medical conditions, diseases and injuries with the acts, omissions, products or services that cause such medical conditions, diseases and injuries to capture a currently untapped latent market for personal injury legal services by informing potential personal injury plaintiffs of their legal rights, as such rights relate to the medical conditions, diseases and injuries that may have been caused by a product or service. Currently, information found on the Internet relates to either medical conditions, diseases and injuries (health issues) or to acts, omissions, products or services (legal issues), but not both. Information currently available on the Internet does not demonstrate the relationship between the two issues. By utilizing a relational database to associate medical conditions, diseases and injuries with the acts, omissions, products or services responsible for causing such medical conditions, diseases and injuries, and by informing the user of the legal principles involved, the method will act to facilitate the initiation of a legal cause of action which otherwise may not have developed.

Another object is to provide an online client procurement system for personal injury attorneys that segregates potential personal injury plaintiffs based on their geographic location by utilizing a case intake system which queries a database seeking the personal injury attorney who has purchased the rights to cases originating from the user's zip code. In addition, the system will query the user with regard to specific and detailed information (the context of which is based on the particular medical condition, disease, injury, product or service that the user is researching) necessary for an attorney to evaluate the merits of the user's case. Such a system will allow attorneys who do not wish to represent clients outside of the attorney's geographical area to avoid the inefficiencies involved (unnecessary telephone calls and other communication) when a non-local client seeks representation. In addition, the user's response to the detailed and specific query will allow the attorney to quickly and efficiently evaluate whether to accept the user as a client.

Another object is to provide an online client procurement system for personal injury attorneys that acts to consolidate the practice of personal injury representation throughout the United States by taking advantage of economies of scale available in advertising and marketing media.

### BRIEF DESCRIPTION OF THE DRAWING

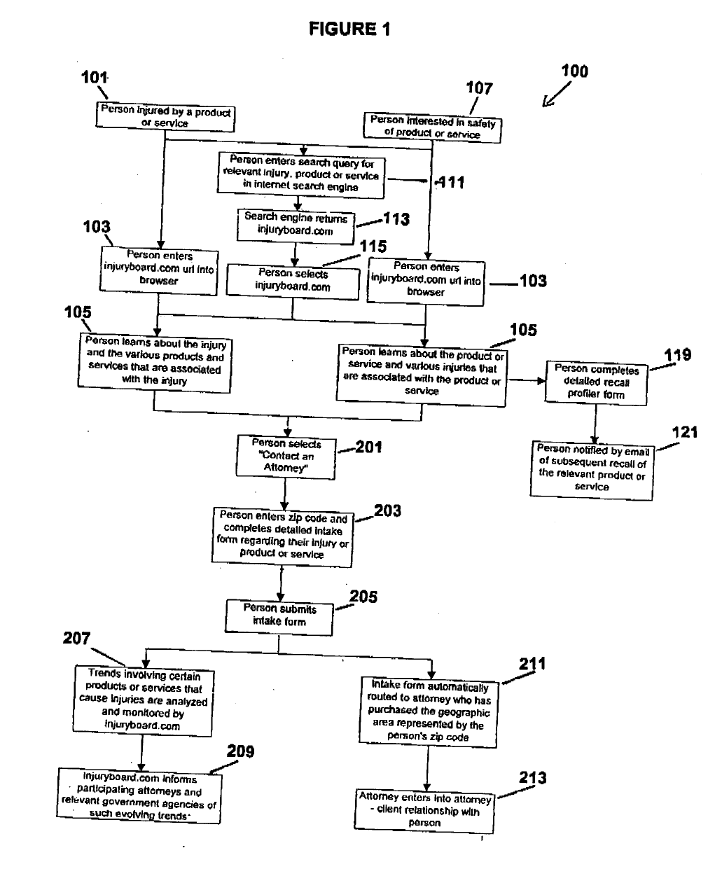

The present invention will now be described, by way of example only, with the reference to the accompanying drawing in which FIG. 1 is a flowchart depicting the primary component of the business method and the steps of the system and its method.

### DESCRIPTION OF THE PREFERRED EMBODIMENT

FIG. 1 illustrates an online client procurement system 100 for personal injury attorneys, which comprises a business method for procuring clients for attorneys which utilizes a relational database that associates information relating to various medical conditions, diseases and injuries with the acts, omissions, products and services that commonly cause such medical conditions, diseases and injuries; a detailed medical and legal intake form customized to reflect the user's medical condition, disease, injury, product or service; a feature that routes such intake forms to the attorney who has purchased the rights to the geographical area represented by the user's zip code, state boundary, or telephone area code; a product recall profiler that allows users to be notified when products the user has indicated interest in are recalled or their safety otherwise called into question; a system for tracking, monitoring, analyzing and reporting medical conditions, diseases and injuries that are caused by acts, omissions, products or services. The database associates information relating to various medical conditions, diseases and injuries with the acts, omissions, products and services that commonly cause such medical conditions, diseases and injuries. Intake forms are highly specialized based on the location of the user within the database and the forms are used by subscribing attorneys to evaluate the merits of the user's/potential client's case. The intake form is routed to an attorney who has purchased the rights to the geographical area represented by the user's zip code. The user may complete a detailed profile form describing products or services of interest to the user. At such time that the products or services of interest become the subject of a recall, the user shall be so notified via electronic mail. The monitoring and tracking system evaluates developing trends with regard to acts, omissions, products or services that cause medical conditions, diseases and injuries in order to report such trends to the proper government agencies and to attorneys who subscribe to the service.

The system 100 as shown in FIG. 1, refers to the available steps the database provides with the coordination of the medical and legal intake form for the selective use by a client or potential client.

The flow diagram shows a person injured by a product or service (101) could enter a search query (111) or enter a injuryboard.com URL into browser (103) and if the individual or persons learns about the various products and varied services that are associated with the injury at this stage can select to contact an attorney (201) within a specified geographical area by using the U.S. postal system zip code, state boundary, or telephone area code (203) and at the same time complete and submit the medical and legal intake form (205).

In an alternative approach to the selection process, an individual or persons (107) interested in safety of products or services could enter a search query (111) or enter the injuryboard.com URL into the browser (103). At that time, the search engine returns injuryboard.com (113), and the individual or persons select injuryboard.com (115) and evaluates the product or services (105) proceeding on to completed detailed recall profile form (119). This individual or persons, is subsequently contacted and notified by electronic mail communication (121) recall of the available relevant product or service.

The essential purpose of this selective database is to establish a connection and to establish a working relationship between the individual or persons so affected, so that an online client procurement system is functional and established with an attorney, and more specifically with a personal injury attorney.

One stage of the system and its method is essential when the medical and legal intake form duly completed is submitted (205). This step establishes a definite attorney/Client relationship.

The next step is a selective one, in one option the intake medical and legal form, is routed to an assigned attorney (211) who has either purchased the system or method, granting the attorney to represent the client in a distinct geographical area demarcated by the U.S. Postal service zip code, state boundary, or telephone system area code, so as to establish the desired attorney/client relationship (213).

However, one other facet of the medical and legal intake form that has been submitted (205) could provide a different trend involving certain products or services that causes injuries are analyzed and monitored by the injuryboard.com (207). It is for the injuryboard.com (207) to inform participating attorneys and relevant government agencies of such evolving trends (209).

The database associates information relating to various medical conditions, diseases and injuries with the acts, omissions, products and services that commonly cause such medical conditions, diseases and injuries. Information contained in the database is accessible through an Internet website interface. The information is arranged hierarchically with the acts, omissions, products and services referred to as “Causes” and the medical conditions, diseases and injuries that result from such acts, omissions, products or services referred to as “Effects.” There are various levels and several sub-levels of causes and effects. For instance, to date Cause Level 1 includes categories titled “Airlines, Cruise Lines & Other Mass Transit,” “Automobile & Motorcycle Accidents,” “Defective & Dangerous Products,” “Doctors, Hospitals, Nurses, & Managed Care,” “Drugs, Medical Devices & Implants,” “Government Negligence,” “Nursing Home & Daycare Abuse,” “Police Misconduct & Inmate Abuse,” “Property Owner's Liability,” “Toxic Substances,” “Violence,” and “Workplace Injuries.” Within each of these Cause Level 1 categories are several sub-categories referred to as Cause Level 2 categories, in turn, within each Cause Level 2 category are further sub-categories referred to as Cause Level 3 categories. Theoretically this cause level hierarchy can contain an infinite number of sub-categories, with each sub-category falling within the subject matter of the category immediately preceding it. The same concept applies to the Effects side of the database. For instance, to date there is an Effects Level 1 which contains categories titled “Blood Disorders,” “Bone, Joint, & Muscle Disorders,” “Cancer,” “Children's Health Issues,” “Digestive Disorders,” “Ear, Nose & Throat Disorders,” “Emotional Problems,” “Eye Disorders,” “Head, Spinal Cord, Brain & Nerve Disorders,” “Heart Problems,” “Hormonal Disorders,” “Immune Disorders,” “Infections,” “Kidney & Urinary Tract Disorders,” “Liver & Gallbladder Disorders,” “Lung & Airway Disorders,” “Men's Health Issues,” “Mouth & Dental Disorders,” “Nutritional & Metabolism Disorders,” “Poisoning & Overdose,” “Skin Disorders,” “War Syndromes,” and “Women's Health Issues.” Within each of these Effect Level 1 categories are several sub-categories referred to as Effect Level 2 categories, in turn, within each Effect Level 2 category are further sub-categories referred to as Effect Level 3 categories. Theoretically, this effect level hierarchy can contain an infinite number of sub-categories, with each sub-category falling within the subject matter of the category immediately preceding it. The various causes (acts, omissions, products or services) and their associated effects (medical conditions, diseases and injuries) are linked together in the relational database. The Internet website interface will arrange and present the information found in these categories and sub-categories in an easy to understand and consumer friendly format. The cause and effect database is never static, as such; new causes and effects may be included in the database at any time in the future. In addition, if a cause other than an act, omission, product or service is identified, it too may be added to the cause side of the database. Likewise, if an effect other than a medical condition, disease, or injury is identified, it too may be added to the effect side of the database.

Intake medical and legal forms are highly specialized based on the location of the user within the database. The forms are used by subscribing attorneys to evaluate the merits of the user's/potential client's case. The intake forms are customized to reflect the subject matter of the Internet website page which the user is viewing at the time the user chooses to submit an electrical intake form. For instance, if the user is viewing a page regarding the medical conditions, diseases and injuries that may result from nursing home neglect, the intake form presented to the user is customized to elicit specific and very detailed information regarding the user's particular facts and circumstances as they relate to the complaint of nursing home neglect. Such customized intake forms will allow the attorney who has purchased the rights to the geographic area represented by the user's zip code to quickly, efficiently, and more thoroughly evaluate the user's claim. Other information may be requested from the user as the need for such information is identified.

The intake form is routed to an attorney (201) who has purchased the rights to the geographical area represented by the user's zip code, state boundary, or telephone area code (211). The completed intake form is automatically and seamlessly routed via electronic mail or other graphical user interface to the attorney or law firm that has purchased the rights to evaluate the intake forms generated from the geographical area represented by the zip code entered on the intake form. Alternatively the geographical area could be drawn up based on the attorney's telephone area code. This routing mechanism allows the attorney to evaluate cases within the attorney's geographic location. At this time, the rights associated with a particular zip code or telephone area code can belong to only one attorney or to one law firm, i.e., the territories are exclusive. In the future certain types of cases may be routed to attorneys who express an interest in such types of cases. For instance, in the future the rights to evaluate intake forms may be based on more than simple geographic location. To illustrate, it would be possible to have several attorneys participate within the same zip code if one attorney has purchased the rights to automobile accidents in such zip code, while another has purchased the rights to drug products liability in such zip code, while yet another has purchased the rights to medical malpractice in such zip code, and so on and so forth. In addition, other geographic locating mechanisms may be utilized in lieu of zip codes. For instance, area codes may be used rather than zip codes.

The user may complete a detailed profile form describing products or services of interest to the user. At such time that the products or services of interest become the subject of a recall, or the safety of such products or services is called into question, the user shall be so notified via electronic mail. Other information may be elicited from users in the future and other electronic mail messages may be generated with regard to such additional information.

The monitoring and tracking system evaluates developing trends (207) with regard to acts, omissions, products or services that cause medical conditions, diseases and injuries in order to report such trends to the proper government agencies and to attorneys who subscribe to the service. The monitoring and tracking component of this business method evaluates trends associated with medical conditions, diseases and injuries reported by users of the Internet website. Such trend analysis allows the owner of the trend information (injuryboard.com) to anticipate future legal actions against those legally responsible for acts, omissions, products or services well in advance of government agencies and other law practice related entities. Through such system injuryboard.com becomes the central clearinghouse for safety related reporting.

The business method consists of a database relating various medical conditions, diseases and injuries to the acts, omissions, products or services that typically cause such medical conditions, diseases and injuries. The database is accessible to the public through an Internet website interface. A person who has an interest in learning more about a particular medical condition, disease, injury, act, omission, product or service may utilize the website. Many of the website users may be unaware that they have a legal cause of action against an entity or individual associated with the act, omission, product or service that caused their medical condition, disease or injury. The website fuses the information about medical conditions, diseases, injuries, acts, omissions, products or services with legal information regarding topics of interest to people who may have a legal cause of action in tort or personal injury. The website educates the user about legal processes and in doing so enlightens the user to the possibility of filing suit against the entity or individual associated with the act, omission, product or service that caused the user's medical condition, disease or injury. This education process acts to capture a client and create a legitimate lawsuit that otherwise may not have materialized because of the user's ignorance of the possibility of filing suit. The subtle connection between the medical information and legal information found on the website facilitates the development of such a lawsuit. Once the user becomes aware of the possibility of filing suit, the user can electronically submit a detailed and specialized intake form which queries the user based on the subject of the user's cause of action. For instance, if the user is viewing a web page on the injuryboard.com site that relates to medical malpractice in the delivery of infants, the case intake process will ask the user to complete a customized form which relates to the specific types of questions that an attorney who wishes to prosecute such cases will need answers to in order to evaluate the merits of the case. Such system assists both the user and the attorney. The user is able to receive a case evaluation without the need to visit an attorney's office, which visits are often fraught with anxiety and inconvenience. The attorney can quickly and efficiently evaluate the intake form that he receives via electronic mail and determine whether the user may have a cause of action. This process eliminates the need for inefficient telephone conversations and in-person meetings that otherwise would be necessary to evaluate a potential client's potential cause of action. Once complete, the intake form is routed to the attorney or law firm that has purchased the right to receive intake forms from specific geographical areas represented by the zip code that the user entered on the intake form. It is at this point that the attorney or law firm evaluates the merits of the information contained in the intake form and responds to the user with either an offer to represent the user or some other appropriate response. Aside, or in conjunction with completing an intake form, the user can also complete the recall profiler. The recall profiler is a form into which the user enters information regarding products or services which the user wishes to receive information on in the event the product or service is recalled or its safety is otherwise called into question. When such product or service is recalled or its safety is called into question, the injuryboard.com will send an electronic mail message so notifying the user. The injuryboard.com monitors, tracks, analyzes and reports trends involving the safety of acts, omissions, products and services which are reported to the injuryboard.com. Such monitoring, tracking, analyzing and reporting allows injuryboard.com to notify its participating attorneys of such developing trends, thus allowing those participating attorneys to be the “first on the scene” with regard to litigation relating to such trends.

What is claimed is:

1. An online procurement system that provides establishing of a direct Attorney/Client relationship between individual(s) as Client and the Attorney in question, wherein the Attorney is located in a specific geographic location with respect to the client.

2. A system as claimed in claim 1, wherein the attorney is at least in personal injury legal practice within a particular geographical location, and the client may seek the service of the attorney in a specific geographical location, such as a state boundary.

3. A system as claimed in claim 2, wherein the system includes a related database for tracking, monitoring and analyzing, comprising medical conditions of the Client constituted by differing diseases and physical injuries.

4. A system as claimed in claim 3, wherein the database incorporates a specific medical and legal form that specifies the client's medical history and condition, whereby to enable the evaluation by the attorney of the client's medical condition.

5. A system as claimed in claim 4, wherein the medical form is routed to a particular attorney in a defined geographical area constituted by the attorney's U.S Postal service Zip Code.

6. A system as claimed in claim 5, wherein the medical form may include a detailed profile of the User and of the products and services that the User is interested in or intends to avail.

7. A system as claimed in claim 3, wherein the monitoring, tracking and analyzing evaluates the user's state of medical and physical conditions so as to assess acts, omissions, products or services that results in the user's medical conditions, diseases and injuries so as to report such a evaluation to the appropriate local and state or federal government authorities and to the respective attorneys that are subscribing to the services.

8. A system as claimed in claim 7, wherein the database is accessible through an Internet website interface, with defined information such as acts, omissions, products and services, generally known in medical and legal professions as “Causes” and similarly the medical conditions, diseases and injuries that result from such acts, omissions, products and services as “Effects”.

9. A system as claimed in claim 8, wherein the various “Causes” and “Effects” as entered in the database is closely coordinated and initiated in user-friendly format.

10. A system as claimed in claim 9, wherein the database maybe subject to review and subsequent change to reflect new “Causes” and “Effects”.

11. A system as claimed in claim 10, wherein the specific intake form for a particular user, can be customized to acquire detailed physical and medical conditions of a particular user, so as to enable the user and the attorney in a particular geographical location to evaluate condition in a co-operative manner.

12. A system as claimed in claim 11, wherein the geographical location will be exclusive to an attorney in practice independently or within a particular law firm for exclusive Zip-Code territorial rights.

13. A system as claimed in claim 12, wherein the user/attorney relationship in a particular geographical location, may also be assigned exclusively for differing medical and legal situations.

14. A system as claimed in claim 1, wherein the geographical location could also be distributed exclusively using a telephone area code as the boundaries for specific service.

15. A system as claimed in claim 1, wherein the attorney/client relationship will be established through electronic communication of the Internet, or such electronics suitable for communication between attorney and the client.

16. A system as claimed in claim 1, wherein the system enables the attorney/client relationship to establish a trend information such as an injury board organization to direct channels for the future legal action specifically against those responsible for acts, omissions, products or services in an orderly manner ahead of other legal entities, governmental agencies and local authorities.

17. A method of online Client procurement through the use of the Internet, and to establish by the following steps:
a) Establishing entry to a relational database in the Internet, established by an Attorney;
b) Reviewing the database and coordinating with the Attorney, specifically located in a geographical location with respect to a potential Client, such as a state boundary.

18. A method as claimed in claim 17, characterized by the attorney being at least in personal injury legal practice within a particular geographical location, and the database establishing the geographical location for a specific Attorney with which the client can establish an attorney/client relationship.

19. A method as claimed in claim 18, characterized by reviewing of a database medical and legal form that incorporates data relating to the client's medical and physical conditions of which information can be appropriately tracked, monitored and analyzed, in which the database will provide the specific medical condition and physical injuries; including the client's medical history, which may be evaluated by the attorney in that geographical location.

20. A method as claimed in claim 19, characterized by the medical form with the database being routed to a specific attorney within a defined geographical location constituted by the attorney's U.S Postal services Zip Code.

21. A method as claimed in claim 20, characterized by the database medical form providing a detailed profile of the user and of the Products and Services, the Client as a user may be interested in and intends to avail.

22. A method as claimed in claim 19, characterized by the steps of monitoring, tracking and analyzing by the attorney to provide an evaluation of the client's (user) medical and physical condition and to assess any acts, omissions, products or services that has resulted in the client's medical and physical conditions, diseases and injuries which have to be evaluated for eventual reporting to appropriate authorities, such as local authorities, state and federal government agencies by the attorney that are subscribing to the services.

23. A method as claimed in claim 22, characterized by the database providing information that is accessible by the Client, the database defines information to establish acts, omissions, products and services, generally known in medical and legal profession as “Causes” and likewise the medical conditions, diseases and injuries that result from such acts, omission, products or services as “Effects”.

24. A method as claimed in claim 23, characterized by the different “Causes” and “Effects” as entered in the database is closely coordinated and initiated in user-friendly format, which can be readily reviewed and subsequently amended to reflect different “Causes” and “Effects” as may be decided by the attorney/client relationship.

25. A method as claimed in claim 24, characterized by the specific medical form intake for the client, can be customized to acquire detailed physical condition of a particular user, so as to enable the user and the attorney in a particular geographical location to evaluate condition in a cooperative manner.

26. A method as claimed in claim 25, characterized by establishing exclusively geographical territory for an individual attorney or within a particular law firm assigned to a specific Zip Code or a state boundary.

27. A method as claimed in claim 25, characterized by the establishing of a user/attorney relationship in a particular geographical location, may also be exclusively adapted for differing medical and legal situations.

28. A method as claimed in claim 17, characterized by the geographical location that could also be exclusively distributed using telephone area codes as the boundaries for specific services.

29. A method as claimed in claim 17, characterized by the steps of establishing a client/attorney relationship through electronic communication of the Internet or such communication channels that may be electronically suitable for communication between attorney and client.

30. A method as claimed in claim 17, characterized by the steps of enabling an attorney/client relationship so as to establish a trend with trend information that maybe coordinated with an injury board organization to direct future legal action channels, specifically against those responsible for acts, omissions, products or services in an orderly manner ahead of other legal entities, governmental agencies and local authorities.
